(19) United States
(12) Patent Application Publication
(10) Pub. No.: US 2025/0118145 A1
(43) Pub. Date: Apr. 10, 2025

(54) Gaming Machine with a Hinged Display

(71) Applicant: Ainsworth Game Technology Limited, Newington (AU)

(72) Inventors: Ivan Antonio Valdes, Pemulwuy (AU); Graham Arthur Brown, Caringbah South (AU)

(21) Appl. No.: 18/483,208

(22) Filed: Oct. 9, 2023

(51) Int. Cl. G07F 17/32

(52) U.S. Cl. CPC G07F 17/3216

(57) ABSTRACT

A gaming machine comprises a cabinet defining an internal space and a display mountable to the cabinet. The display at least partly covers the internal space in a closed position and is hingedly connected to the cabinet. The display is pivotable about a first hinge in an upward direction from the closed position to a first position. The display is also pivotable in a downward direction about a second hinge from the first position to a second position. The display in the second position enables easier access to the internal space and the rear of the display for maintenance tasks. The display may also be removed from the cabinet in the second position.

### BACKGROUND

The present disclosure relates to a gaming machine with a hinged display and a method. The present disclosure has been developed primarily for use as an electronic gaming machine and will be described hereinafter by reference to this application. However, it will be appreciated that the present disclosure may also be implemented for any type of gaming machine, including a mechanical or electro-mechanical gaming machine.

The following discussion of the prior art is intended to present the present disclosure in an appropriate technical context and allow its advantages to be properly appreciated. Unless clearly indicated to the contrary, however, reference to any prior art in this specification should not be construed as an express or implied admission that such art is widely known or forms part of common general knowledge in the field.

The design of gaming machines has evolved over time in response to consumer demand for more visually striking and aesthetically attractive games and gaming machines. One development in response to this demand, is the provision of additional screens or displays, or larger screens or displays, that enable more game play and the ability to provide enhanced audio and/or visual effects. There is also usually an audio-visual screen display used for displaying the name of the game(s) played on the gaming machine and/or providing audio visual effects, commonly known as a “topper.”

As a consequence of these developments, the height of these types of gaming machines have significantly increased, requiring a technician to use a ladder to access the display(s) and topper to perform maintenance, including repair and/or replacement of the display and topper. This results in difficulty in performing these maintenance tasks; for example, it is inconvenient and difficult for the technician to repair or replace the display when situated on a ladder. Consequently, maintenance time is increased and thus labour costs also increase.

It also poses a safety hazard, as there is a greater risk of injury to the technician from falling off the ladder, also necessitates some of the floor space to be closed off to players to perform these maintenance tasks. In addition, it can be difficult to access the internal components of the gaming machine, including supporting components for the display(s), due to the weight of the additional and/or larger screens or the height of the topper.

### SUMMARY

One embodiment of the present disclosure provides a gaming machine comprising:
a cabinet defining an internal space; and
a display mountable to the cabinet and at least partly covering the internal space in a closed position;
wherein the display is hingedly connected to the cabinet to provide access to the internal space; and
wherein the display is pivotable about a first hinge in a first direction from the closed position to a first position and pivotable in a second direction about a second hinge from the first position to a second position, the second direction being different to the first direction.

In one or more embodiments, the gaming machine comprises a mounting assembly for hingedly connecting the display to the cabinet. In one or more embodiments, the mounting assembly is hingedly connected to the cabinet at the first hinge. In one or more embodiments, the first hinge is at or adjacent a top of the cabinet.

In one or more embodiments, the mounting assembly is hingedly connected to the display at the second hinge. In one or more embodiments, the second hinge is located towards a lower end of the display. In one or more embodiments, the second hinge is located at or adjacent the lower end of the mounting assembly. In one or more embodiments, the second hinge is located at a rear of the display.

In one or more embodiments, the mounting assembly comprises a mounting arm for supporting the display. In one or more embodiments, the first hinge is located at or adjacent a first end of the mounting arm. In one or more embodiments, the first end comprises an upper end of the mounting arm.

In one or more embodiments, the second hinge is located at or adjacent a second end of the mounting arm. In one or more embodiments, the second end comprises a lower end of the mounting arm.

In one or more embodiments, the mounting assembly comprises at least two mounting arms for supporting the display. In one or more embodiments, there are at least two first hinges located at or adjacent respective first ends of the at least two mounting arms. In one or more embodiments, the first ends comprise an upper end of the at least two mounting arms. In one or more embodiments, there are at least two second hinges located at or adjacent respective second ends of the at least two mounting arms. In one or more embodiments, the second ends comprise a lower end of the at least two mounting arms.

In one or more embodiments, the mounting assembly comprises a frame for mounting the display. In one or more embodiments, the frame is connected to the mounting arm(s).

In one or more embodiments, the display is removable from the mounting assembly in the second position.

In one or more embodiments, one or more support arms are provided for supporting the display in the first position. In one or more embodiments, the one or more support arms also support the display in the second position. The one or more support arms may comprise a bracket, piston, articulated arm, or any combination thereof.

In one or more embodiments, the display is detachably connected to the first hinge(s). In one or more embodiments, the display is configured to connect to the first hinge(s) in a snap-fitting or interference fitting engagement.

In one or more embodiments, the first direction is opposite to the second direction. In one or more embodiments, the first direction is an upward direction relative to the display and the second direction is in a downward direction relative to the display. In one or more embodiments, the display moves along an arcuate path from the closed position to the first position. In one or more embodiments, the display moves along another arcuate path from the first position to the second position.

In one or more embodiments, the display is removable from the cabinet in the second position.

In one or more embodiments, the display in the second position extends away from the cabinet such that an upper end of the display is distal from the cabinet and a lower end of the display is proximal to the cabinet. In one or more embodiments, the display comprises a screen surface and in the second position, the display is orientated such that the screen surface is facing downwardly. In one or more embodiments, the display is laterally displaced from the cabinet in the second position.

In one or more embodiments, the display in the second position is disposed substantially perpendicular to the cabinet. In one or more embodiments, the display in the second position lies in a substantially horizontal plane.

In one or more embodiments, the display is pivotable about the first hinge from the first position to a third position. In one or more embodiments, the third position is an open position. In one or more embodiments, the display in the open position is at an acute angle to the cabinet.

In one or more embodiments, the first position is a release position of the display.

In one or more embodiments, the second position is an extended position of the display relative to the cabinet.

In one or more embodiments, the gaming machine comprises a secondary display mounted above the display, wherein the secondary display is pivotable about a third hinge from a closed position of the secondary display to an open position of the secondary display. In one or more embodiments, the open position of the secondary display permits access to an internal opening of the secondary display.

In one or more embodiments, the secondary display is mounted to the cabinet via a support structure. In one or more embodiments, the support structure comprises a base portion for supporting the secondary display and for covering for the internal opening. In one or more embodiments, the support structure comprises a bridging portion connecting the secondary display to the cabinet.

In one or more embodiments, the secondary display is hingedly connected to the support structure at the third hinge. In one or more embodiments, the third hinge is located on the base portion of the support structure. In one or more embodiments, the third hinge has a pivot axis substantially perpendicular to a pivot axis of the first hinge and/or second hinge.

Another embodiment of the present disclosure provides a gaming machine comprising:
a cabinet defining an internal space; and
a display mountable to the cabinet and at least partly covering the internal space in a closed position;
a first hinge for pivoting the display in an upward direction relative to the cabinet; and
a second hinge for pivoting the display in a downward direction relative to the cabinet;
wherein the display is pivotable about the first hinge from the closed position to a first position and pivotable about the second hinge from the first position to a second position.

This embodiment may also have one or more features of the previous embodiments of the present disclosure as described above.

Yet another embodiment of the present disclosure provides a method of maintenance or repair of a gaming machine, the gaming machine comprising:
a cabinet and a display mountable to the cabinet, wherein the cabinet defines an internal space and the display at least partly covers the internal space in a closed position and
the display is hingedly connected to the cabinet to provide access to the internal space, the method comprising the steps of:
pivoting the display in a first direction about a first hinge from the closed position to a first position; and
pivoting the display in a second direction about a second hinge from the first position to a second position;
wherein the first direction is different to the second direction.

In one or more embodiments, the method comprises the removing the display from the cabinet in the second position.

In one or more embodiments, the method comprises hingedly connecting the display to the cabinet with a mounting assembly, operating the mounting assembly to pivot the display from closed position to the first position and operating the mounting assembly form the first position to the second position. In one or more embodiments, the method comprises hingedly connecting the mounting assembly to the cabinet at the first hinge. In one or more embodiments, the method comprises hingedly connecting the mounting assembly to the display at the second hinge. In one or more embodiments, the method comprises removing the display from the mounting assembly in the second position.

In one or more embodiments, the method comprises moving the display along an arcuate path from the closed position to the first position. In one or more embodiments, the method comprises moving the display along another arcuate path from the first position to the second position.

In one or more embodiments, the method comprises disposing the display in the second position to extend away from the cabinet such that an upper end of the display is distal from the cabinet and a lower end of the display is proximal to the cabinet. In one or more embodiments, the display comprises a screen surface and the method comprises orientating the display in the second position such that the screen surface is facing downwardly.

In one or more embodiments, the method comprises disposing the display in the second position to be substantially perpendicular to the cabinet. In one or more embodiments, the method comprises disposing the display in the second position to lie in a substantially horizontal plane.

In one or more embodiments, the method comprises pivoting the display about the first hinge from the first position to a third position.

In one or more embodiments, the method comprises mounting a secondary display above the display and pivoting the secondary display about a third hinge from a closed position of the secondary display to an open position of the secondary display. In one or more embodiments, the method comprises permitting access to an internal opening of the secondary display in the open position of the secondary display.

In one or more embodiments, the method comprises mounting the secondary display to the cabinet via a support structure. In one or more embodiments, the method comprises supporting the secondary display with a base portion. In one or more embodiments, the method comprises covering the internal opening with the base portion. In one or more embodiments, the method comprises connecting a bridging portion of the support structure to the secondary display and the cabinet.

In one or more embodiments, the method comprises hingedly connecting the secondary display to the support structure at the third hinge. In one or more embodiments, the method comprises locating the third hinge on the base portion of the support structure. In one or more embodiments, the method comprises arranging the third hinge such that the third hinge has a pivot axis substantially perpendicular to a pivot axis of the first hinge and/or second hinge.

This embodiment may also have one or more features of the previous embodiments of the present disclosure as described above.

A yet further embodiment of the present disclosure provides a method comprising:
providing a gaming machine comprising a cabinet defining an internal space and a display for at least partly covering the internal space in a closed position;
mounting the display to the cabinet;
pivoting the display about a first hinge in an upward direction relative to the cabinet from a closed position to a first position; and
pivoting the display about the second hinge in a downward direction relative to the cabinet from the first position to a second position.

This embodiment may also have one or more features of the previous embodiments of the present disclosure as described above.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.”

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

The disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a perspective view of a gaming machine according to a first embodiment of the present disclosure.

FIG. 2 is a perspective view of the gaming machine of FIG. 1 where the console is lifted up;

FIG. 3 is a perspective view of the gaming machine of FIG. 1 where the door is opened;

FIG. 4 is a perspective view of the gaming machine of FIG. 1 where the display is moved to an open position;

FIG. 5 is a side view of the gaming machine of FIG. 1;

FIG. 6 is a side view of the gaming machine of FIG. 2;

FIG. 7 is a side view of the gaming machine of FIG. 3;

FIG. 8 is a side view of the gaming machine of FIG. 4;

FIG. 9 is a side view of the gaming machine of FIG. 1 in a first position;

FIG. 10 is a side view of the gaming machine of FIG. 1 in a transition or intermediate position;

FIG. 11 is a side view of the gaming machine of FIG. 1 in a second position;

FIG. 12 is a perspective view of the gaming machine of FIG. 11;

FIGS. 13 to 15 are side views of the gaming machine of FIG. 1 where the topper is moved to an open position.

### DETAILED DESCRIPTION OF VARIOUS EMBODIMENTS

The present disclosure will now be described with reference to the following examples which should be considered in all respects as illustrative and non-restrictive. In the Figures, corresponding features within the same embodiment or common to different embodiments have been given the same reference numerals.

In general terms, a gaming machine according to the embodiments described herein includes at least one display, and an electronic controller coupled to the at least one display. In some embodiments, the gaming machine comprises a value transfer mechanism or a value input that is coupled to the electronic controller.

The present disclosure provides a gaming machine and method that permits improved maintenance and/or repair by enabling the display to be moved to a position where the internal space housing internal components of the gaming machine can be more easily accessed and a position where the display can be more easily repaired and/or replaced.

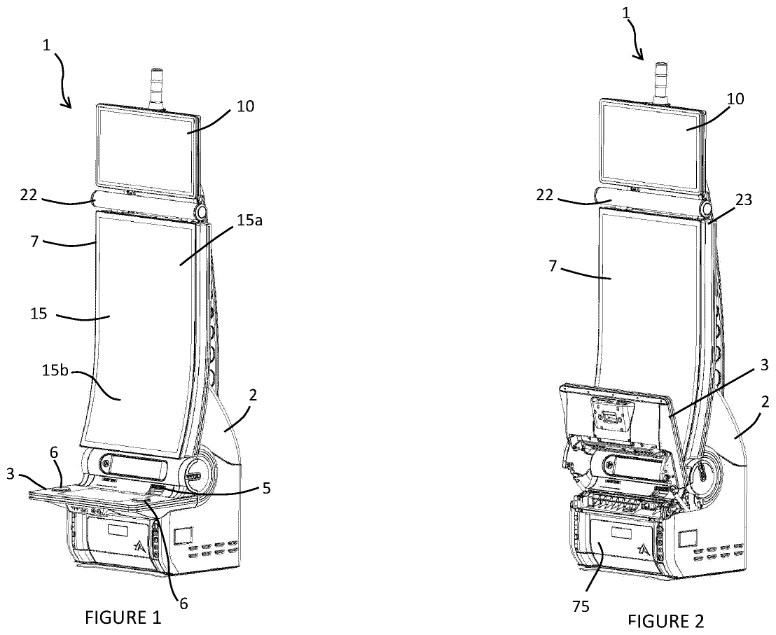

Referring to FIG. 1, a gaming machine 1 according to a first embodiment includes a cabinet 2 and a console 3. The cabinet 2 further defines internal spaces 4a and 4b, in which various internal components of the gaming machine 1 may be stored, such as an electronic controller for controlling the operation of the gaming machine and games played on the gaming machine. The console 3 has various input devices including value inputs, such as vending slots 5 for receiving monetary bets, and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 1. Other forms of value include gaming tokens, paper, tickets, vouchers, and any other object representative of value.

The gaming machine also comprises a display in the form of a video screen 7 and a secondary display in the form of a “topper” 10. The video screen 7 is used to display a game (which can be a base game, feature game or a combination of both) that is played on the gaming machine 1. The topper 10 is used primarily for showing artwork associated with the game(s) that are available for play on the gaming machine, including the game title, as well as for displaying an audio-visual presentation to attract players to the gaming machine 1. The video screen 7 has a screen surface 15, which may be divided into an upper playing area 15a and a lower display area 15b, but can be a single area. The base game and/or feature game may occupy a portion of the screen surface 15, such as the lower display area 15b. The upper display area 15a may be used for game play, such as a feature game, or could be used to also show artwork or other audio-visual elements that are interactive with game play on the lower display area 15b and/or other game information, such as jackpot information.

In this embodiment, the buttons 6 are physical buttons provided on the console 3. However, it will be appreciated that the buttons 6 can be replaced with virtual buttons on the display 7 that are touch sensitive surfaces for receiving commands from the player, the touch sensitive surfaces or virtual buttons being in electronic communication with the controller 4 to transmit the player commands. Alternatively, there may be a combination of buttons 6 on the console 3 and touch sensitive surfaces or virtual buttons on the display 7.

The electronic game controller 4 will transmit and receive signals to and from each of the input devices and the video screen 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) has been verified by the credit verification device, a signal is sent to the electronic game controller, which then determines whether the minimum bet level has been reached. If so, the electronic game controller will permit play of the game on the video screen 7 of the gaming machine 1. If not, the electronic game controller 4 will send a signal to the video screen 7 to show a message requesting further value to be added to the gaming machine 1.

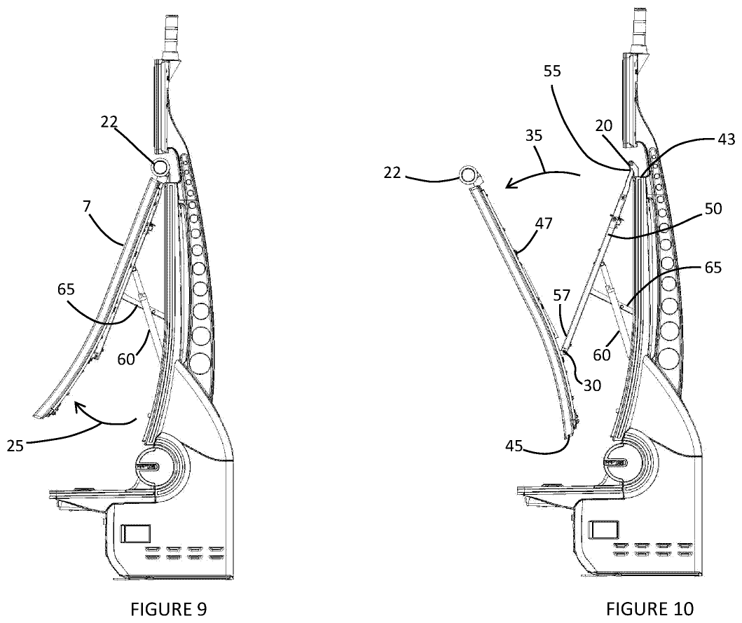

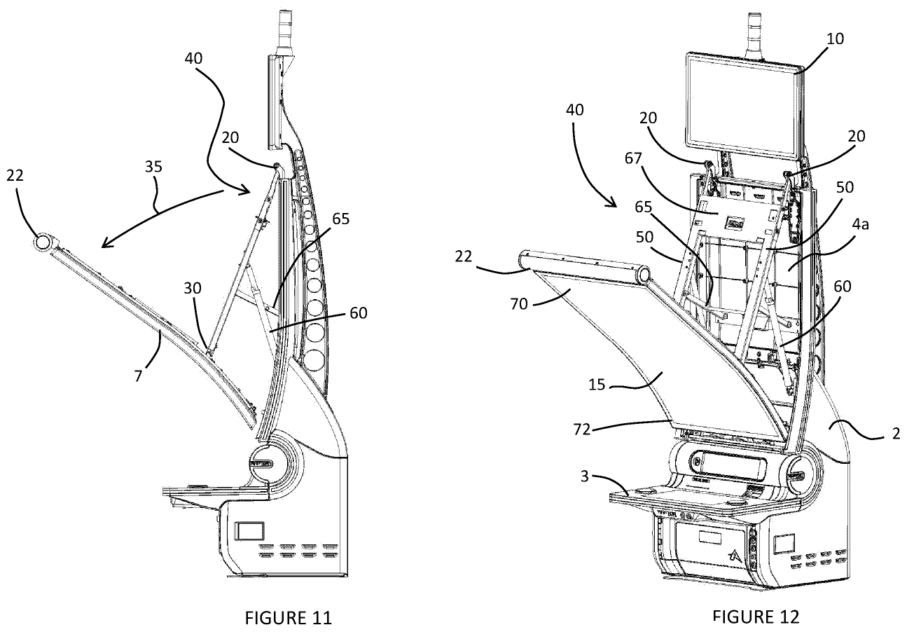

In this embodiment, the video screen 7 is mountable to the cabinet 2 and at least partly covers the internal space 4a in a closed position, preferably fully covering the internal space, as shown in FIG. 1. The video screen 7 is hingedly connected to the cabinet 2 to provide access to the internal space 4a, as best shown in FIGS. 4, 8 and 9. The video screen 7 is pivotable about a first hinge 20 (as best shown in FIGS. 10 to 12), in a first, upward, direction 25 from the closed position to a first position, as best shown in FIGS. 8 and 9. In this embodiment, there is a pair of first hinges 20 that are hidden behind a cylindrical sound bar 22 at a top 23 of the display 7, as best shown in FIG. 12. The display 7 is also pivotable about a pair of second hinges 30 in a second, downward, direction 35 from the first position to a second position, as best shown in FIGS. 10 and 11. It will be appreciated that in other embodiments, there may be a single first hinge 20 and/or single second hinge 30, as well as a multiple number of first and second hinges.

A mounting assembly 40 is provided for hingedly connecting the video screen 7 to the cabinet 2, as best shown in FIGS. 11 and 12. In this embodiment, the mounting assembly 40 is hingedly connected to the cabinet at the first hinges 20, which may be located adjacent or proximate to a top 43 of the cabinet 2. Alternatively, the first hinges 20 are located at the top 43 of the cabinet 2. The mounting assembly 40 is also hingedly connected to the video screen 7 at the second hinges 30, which are located towards or proximate to a bottom 45 of the video screen 7, preferably at a rear 47 thereof, as best shown in FIG. 10. In this case, the second hinges 30 are located about a third of the length of the display 7 from the bottom 45. However, the second hinges 30 may be located at any distance from the bottom 45 up to mid-point on the display 7. Alternatively, the second hinges 30 may be located at or adjacent the bottom 45 of the and/or rear 47 of the video screen 7.

The mounting assembly 40 further comprises a pair of mounting arms 50 for supporting the video screen 7, as best shown in FIG. 12. In this embodiment, the mounting arms 50 are connected to the first and second hinges 20, 30. Compare FIGS. 10 and 11 to FIG. 12. Thus, each first hinge 20 is connected to at an upper end 55 of each mounting arm 50, while each second hinge 30 is connected to a lower end 57 of each mounting arm 50, as best shown in FIG. 10. In this arrangement, the is a set of first and second hinges 20, 30 for each mounting arm 50, as best shown in FIGS. 11 and 12. In other embodiments, the first and second hinges 20, 30 may be located adjacent or proximate to the upper and lower ends 55, 57 of each mounting arm 50, respectively.

The mounting assembly 40 also has a pair of support arms or struts 60 for supporting the video screen 7 in the first position, as best shown in FIG. 9. These support struts 60 are also able to support the video screen 7 in the second position, as best shown in FIGS. 11 and 12, as well as a transition or intermediate position shown in FIG. 10 between the first and second positions. The support struts 60 may each comprise a bracket, piston, and the like. There also may be a secondary support arm or strut 65 in the form of an articulated bracket that assists in supporting the video screen 7 in the first, transition and second positions.

The mounting assembly 40 may also be provided with a frame 67, which in this embodiment takes the form of a H-shaped frame connected to the mounting arms 50, as best shown in FIG. 12. The frame 67 provides some stability for the video screen 7 when fitted to the mounting assembly 40. However, it will be appreciated that in other embodiments, the frame 67 may be omitted.

In this embodiment, the second position is in effect an extended position of the display, where the video screen 7 is displaced laterally from and outwardly of the cabinet 2. This results in the video screen 7 being spaced apart from cabinet 2, allowing for greater access to the internal space 4 of the cabinet. Moreover, the video screen 7 can now be easily and conveniently removed from the cabinet 2 via the mounting assembly 40 for repair and/or replacement.

In addition, in this extended position, the video screen 7 is orientated relative to the cabinet such that the screen surface 15 is facing downwardly. The display 7 also extends away from the cabinet 2 such that an upper end 70 of the display is distal from the cabinet and a lower end 72 of the display is proximal to the cabinet, as best shown in FIG. 12. This permits easy access to the rear of the video screen 7 to access the plug or socket connections between the video screen and the cables leading from the interior space 4a. Furthermore, as the video screen 7 is also disposed closer to the ground, between the top and bottom of the cabinet 2, just above the console 3, a technician can access the video screen 7 safely from the ground and in a more work safe posture (i.e. standing more upright without excessive bending or twisting the back), reducing the risk of workplace injury.

In other embodiments, the display 7 may extend in the second position such that it is substantially perpendicular to the cabinet 2 or lie in a horizontal plane. In this configuration, the display 7 may be more accessible and easier to work on by a technician. In some embodiments, this would involve moving the second hinges 30 toward the bottom 45 of the video screen 7 to provide a greater angle of movement and thus orientate the video screen into a more horizontal position.

The first position of FIG. 9 is in effect a release position, where the video screen 7 is initially separated from the cabinet 7 and there is limited access to the internal space 4a of the cabinet 2. Accordingly, where it is desired to only access the internal space 4a behind the video screen 7, it can be pivoted about the first hinges 20 from the closed position to a third position corresponding to an open position, as best shown in FIGS. 4 and 8. In this position, the mounting arms 50 are not operative and the support struts 60 are used to support the display 7. In this open position, a technician has greater access to the internal space 4a compared to the first position.

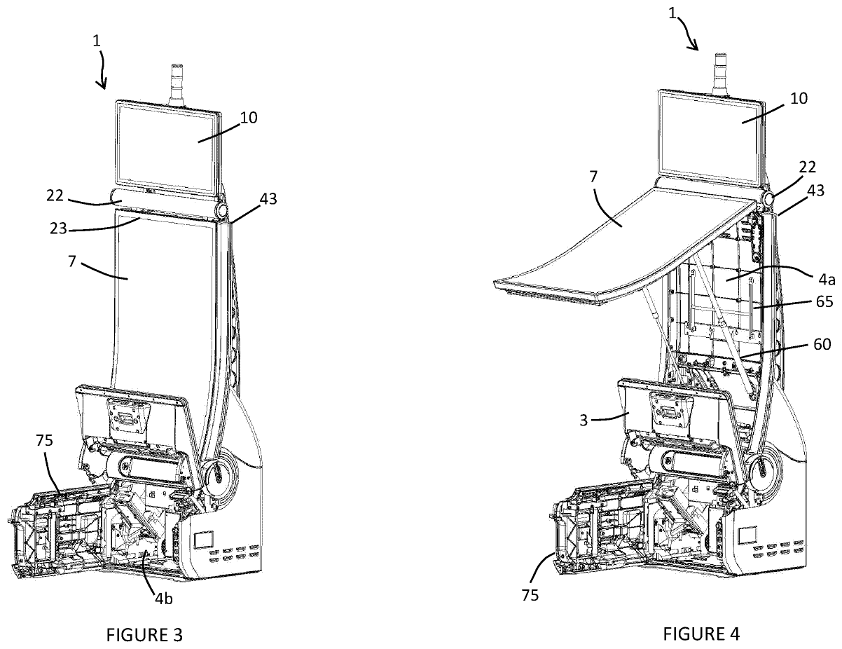

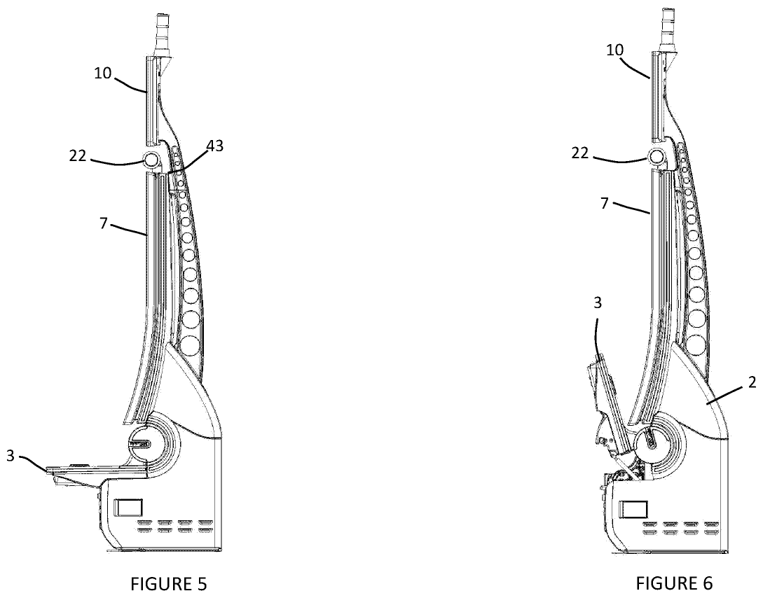

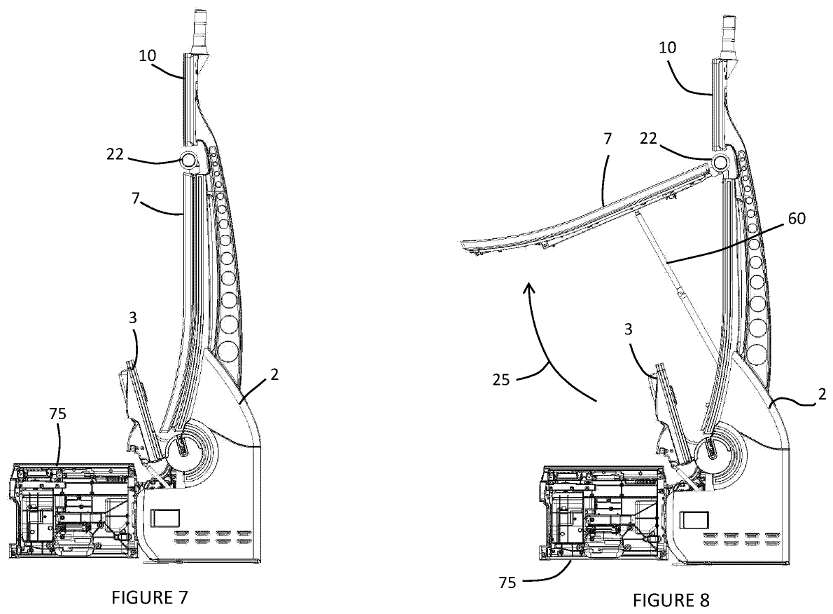

When performing a maintenance task on the gaming machine 1, the technician is able to rotate the console 3 upwards to access a door 75 of the cabinet 2, as best shown in FIGS. 2 and 6. The door 75 is then opened, as shown in FIGS. 3 and 7, to access the internal space 4b where various internal components (as shown in FIGS. 3 and 4) of the gaming machine 1 are stored behind the door in the cabinet 2. The technician can then perform any necessary maintenance or repair tasks in relation to these internal components. The technician may also pivot or rotate the video screen 7 about the first hinges 20 in the upward direction 25 to the open position, as best shown in FIGS. 4 and 8. The support struts 60 may be locked into position to keep the video screen 7 in the open position. Alternatively, a support bracket (not shown) hingedly connected to the cabinet 2 may be rotated or pivoted out and secured to the rear 47 of the video screen 7 (as shown in FIG. 10). The technician is then able to safely access the internal components in the internal space 4a to perform maintenance or repair of these stored components.

To perform a maintenance task on the video screen 7 and/or components in the internal space 4a, the technician releases a catch (not shown) holding the video screen and mounting assembly 40 to the cabinet 2. The video screen 7 is pivoted or rotated from the close position shown in FIG. 1 about the first hinges 20 in the upward direction 25 into the first (release) position, as best shown in FIG. 9. The video screen 7 is supported by the support struts 60 in this position. The video screen 7 is then moved in the same upward direction, travelling along an arcuate path towards a transition position, as best shown in FIG. 10. The support struts 60 may be locked into place to prevent the video screen 7 swinging back towards the cabinet 2. In the illustrated embodiment, the articulated bracket 65 may also be used to lock the video screen 7 into the first position. The video screen 7 is then detached from the first hinges 20 and the upper ends 55 of the mounting arms 50 at the top 43 of the cabinet 2, as best shown in FIG. 10. The video screen 7 is then pivoted or rotated about the second hinges 30 in the downward direction 35, travelling along another arcuate path, towards the floor or bottom of the cabinet 2 into the second position, as best shown by the transition from FIG. 10 to FIGS. 11 and 12.

In this second position, the video screen 7 is extended outwardly from the cabinet 2 with its upper end 70 furthest away and its lower end 72 closest to the cabinet. The screen surface 15 also faces downwardly towards the floor. The technician can now access the rear 47 of the video screen 7, including any plug connections for cables (such as LED cables) from the video screen to the internal components in the internal space 4a of the cabinet 2. Where the video screen 7 is to be replaced, the technician or a pair of technicians can detach the video screen from the mounting arms 50. The second hinges 30 may either also be removed with the video screen 7, stay with the mounting arms 50 or be disassembled to enable removal of the video screen 7. A new video screen 7 is then attached to the second hinges 30 and fitted to the mounting assembly 40. The above steps are then reversed to restore the video screen 7 into the closed position.

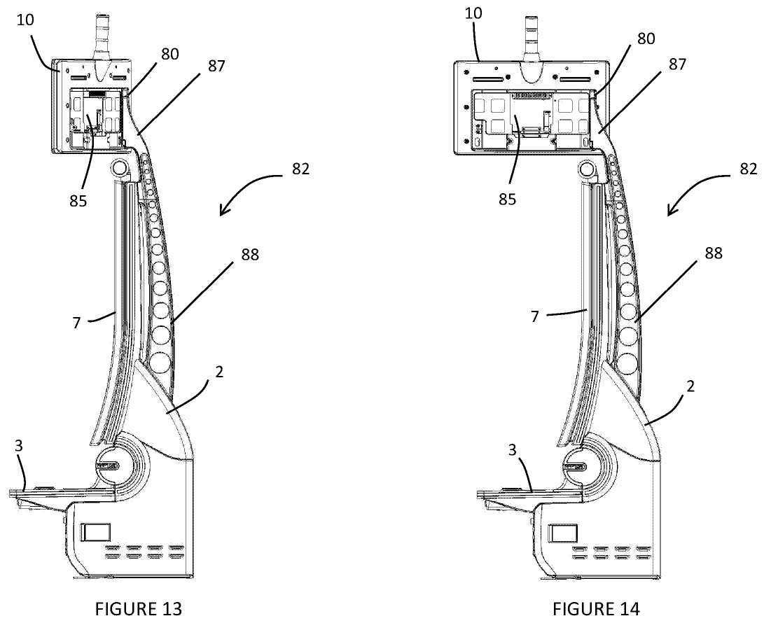

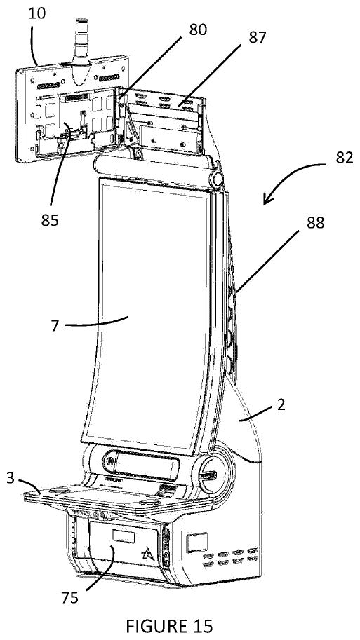

In addition, the technician can actuate or pull a cable or cord (not shown) in the internal space 4a that connects to a latch or lock (not shown) of the topper 10. This releases the topper 10 from the cabinet 2, so it can then be swung outwards about a third hinge 80 from a closed position to an open position, as shown in FIGS. 13 to 15. The third hinge 80 connects the topper 10 to a support structure 82 that is in turn connected to the cabinet 2. This open position enables access to a rear opening 85 of the topper 10 containing components for the topper. Consequently, the rear opening 85 of the topper 10 can be readily and easily accessed safely by the technician with a ladder. In contrast to the prior art, there is no longer any need to attempt to access the internal opening 85 of the topper 10 when standing on the ladder, which carries the risk of the technician toppling from the ladder. Thus, it is no longer awkward in performing this maintenance task and reduces the risk of falls and thus worker injury.

The support structure 82 comprises a base portion 87 for supporting the topper 10 and/or for covering the internal (rear) opening 85. The support structure 82 also comprises a bridging portion 88 connecting the topper 10 to the cabinet 2. Thus, the topper 10 is hingedly connected to the support structure 82 at the third hinge 80. The third hinge 80 is located on the base portion 87 and preferably has a pivot axis substantially perpendicular to a pivot axis of the first hinge 20 and/or second hinge 30. In this embodiment, the pivot axis of the third hinge 80 is substantially vertical, whereas the pivot axes of the first and second hinges 20, 30 are substantially horizontal. However, it will be appreciated that the pivot axes for the first, second and third hinges 20, 30, 80 may be aligned or at acute or obtuse angles to each other.

While the present embodiments of the disclosure have been described with two sets of first and second hinges 20, 30, it will be appreciated that in other embodiments, a single first hinge 20 and/or single second hinge 30 can be provided. Likewise, the single third hinge 80 can be replaced with multiple third hinges 80. Similarly, while the mounting assembly 40 is described as having two mounting arms 50 and two supporting struts 60, a single mounting arm and/or single strut may be used in other embodiments.

It will further be appreciated that any of the features in the preferred embodiments of the present disclosure can be combined together and are not necessarily applied in isolation from each other. Similar combinations of two or more features from the above-described embodiments or embodiments of the present disclosure can be readily made by one skilled in the art.

By providing a display that this pivotable in two directions above respective first and second hinges, the embodiments of the present disclosure provide a convenient, safe, and less labour-intensive way of performing various maintenance tasks on a gaming machine, including repair and/or replacement of the main video display. As the display can be moved to a position closer to the ground, a technician can more safely maintain or repair the display in a more work safe posture, minimising workplace injury, for example due to a back injury from twisting or bending their backs or falling from a ladder. It is also more convenient to perform these maintenance or repair tasks on the ground rather than on a ladder or in an awkward position. The display can also be more easily and safely removed from the gaming machine from the extended position than when it is upright when installed on the gaming machine cabinet. It also allows for more convenient and easier access to internal components stored in the internal space of the cabinet of the gaming machine. Hence, maintenance time and labour costs are decreased. In all these respects, the present disclosure represents a practical and commercially significant improvement over the prior art.

In conclusion, although the preceding text sets forth a detailed description of different embodiments of the present disclosure, it should be understood that the legal scope of the present disclosure is defined by the words of the claims set forth at the end of this patent. The detailed description is to be construed as exemplary only and does not describe every possible embodiment of the present disclosure since describing every possible embodiment would be impractical, if not impossible. Numerous alternative embodiments could be implemented, using either current technology or technology developed after the filing date of this patent, which would still fall within the scope of the claims defining the present disclosure.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

1. A gaming machine comprising:
a cabinet defining an internal space; and
a display mountable to the cabinet and at least partly covering the internal space in a closed position;
wherein the display is hingedly connected to the cabinet to provide access to the internal space; and
wherein the display is pivotable about a first hinge in a first direction from the closed position to a first position and pivotable in a second direction about a second hinge from the first position to a second position, the second direction being different to the first direction.

2. The gaming machine of claim 1, comprising a mounting assembly for hingedly connecting the display to the cabinet, wherein the mounting assembly is hingedly connected to the cabinet at the first hinge and hingedly connected to the display at the second hinge.

3. The gaming machine of claim 2, wherein the mounting assembly comprises a mounting arm supporting the display, the first hinge being located at or adjacent a first end of the mounting arm and the second hinge being located at or adjacent a second end of the mounting arm.

4. The gaming machine of claim 2, wherein the first hinge is at or adjacent a top of the cabinet and the second hinge is located towards or adjacent a lower end of the mounting assembly.

5. The gaming machine of claim 2, wherein the display is detachably connected to the first hinge.

6. The gaming machine of claim 1, wherein the display is detachably connected to the first hinge.

7. The gaming machine of claim 1, wherein the display is removable from the cabinet in the second position.

8. The gaming machine of claim 1, wherein the display moves along an arcuate path from the closed position to the first position and the display moves along another arcuate path from the first position to the second position.

9. The gaming machine of claim 1, wherein the display in the second position extends away from the cabinet such that an upper end of the display is distal from the cabinet and a lower end of the display is proximal to the cabinet.

10. The gaming machine of claim 1, comprising a secondary display mounted above the display, wherein the secondary display is pivotable about a third hinge from a closed position of the secondary display to an open position of the secondary display.

11. The gaming machine of claim 10, wherein the secondary display is mounted to the cabinet via a support structure, wherein the secondary display is hingedly connected to the support structure at the third hinge and the support structure comprises a base portion for supporting the secondary display and a bridging portion connecting the secondary display to the cabinet.

12. A gaming machine comprising:
a cabinet defining an internal space;
a display mountable to the cabinet and at least partly covering the internal space in a closed position;
a first hinge for pivoting the display in an upward direction relative to the cabinet; and
a second hinge for pivoting the display in a downward direction relative to the cabinet; and
wherein the display is pivotable about the first hinge from the closed position to a first position and pivotable about the second hinge from the first position to a second position.

13. The gaming machine of claim 12, comprising a mounting assembly for hingedly connecting the display to the cabinet, wherein the mounting assembly is hingedly connected to the cabinet at the first hinge and is hingedly connected to the display at the second hinge.

14. The gaming machine of claim 13, wherein:
the mounting assembly comprises at least two mounting arms for supporting the display;
there are at least two first hinges located at or adjacent a top of the cabinet and at or adjacent respective upper ends of the at least two mounting arms; and
there are at least two second hinges located towards a lower end of the display and at or adjacent respective lower ends of the at least two mounting arms.

15. The gaming machine of claim 12, wherein the display is detachably connected to the first hinge.

16. The gaming machine of claim 12, wherein the display is removable from the cabinet in the second position.

17. The gaming machine of claim 12, wherein the display moves along an arcuate path from the closed position to the first position and the display moves along another arcuate path from the first position to the second position.

18. A method of maintenance or repair of a gaming machine, the gaming machine comprising a cabinet and a display mountable to the cabinet, wherein the cabinet defines an internal space and the display at least partly covers the internal space in a closed position, and the display is hingedly connected to the cabinet to provide access to the internal space, the method comprising the steps of:
pivoting the display in a first direction about a first hinge from the closed position to a first position; and
pivoting the display in a second direction about a second hinge from the first position to a second position;
wherein the first direction is different to the second direction.

19. The method of claim 18, comprising the removing the display from the cabinet in the second position.

20. The method of claim 18, comprising moving the display along an arcuate path from the closed position to the first position and moving the display along another arcuate path from the first position to the second position.
